(19) United States
(12) Patent Application Publication
(10) Pub. No.: US 2010/0117416 A1
(43) Pub. Date: May 13, 2010

(54) Child seat

(75) Inventor: Kenny Cheng, Taipei (TW)

Correspondence Address: BACON & THOMAS, PLLC, 625 SLATERS LANE, FOURTH FLOOR, ALEXANDRIA, VA, 22314-1176, US

(73) Assignee: Wonderland Nurserygoods Co., Ltd., Taipei (TW)

(21) Appl. No.: 12/591,182

(22) Filed: Nov. 12, 2009

Related U.S. Application Data
(60) Provisional application No. 61/113,603, filed on Nov. 12, 2008.

(51) Int. Cl. A47D 1/10; B60N 2/26; B60N 2/28; A47D 13/02; A47D 1/00; B29C 45/14

(52) U.S. Cl. 297/250.1; 264/250

(57) ABSTRACT

The present invention relates to a child seat, in particular a child seat having a flexible integrally formed thereon, and does not need any additional clothing or pad to be attached to the body thereof. The flexible member 16 is integrally formed directly on the body 18 of the child car seat 1 by over-molding process. The present invention applies a two-molding step process to forme the flexible member onto the body of the seat portion. By such arrangement, the manufacturing cost and assembling time can be reduced.

### CROSS REFERENCE

This application claims the benefit of U.S. Provisional Patent Application No. 61/113,603, filed Nov. 12, 2008, which application is incorporated herein by reference in its entirety.

### BACKGROUND OF THE INVENTION

1. Field of the Invention

The present invention generally relates to a child seat, in particular a child seat having a flexible integrally formed thereon, and does not need any seat clothing or pad to be attached to the body thereof.

2. Background Information

The child seats now available on the market, such as the child car seat or the high chair, are commonly attached with soft goods on the body shell so as to increase the softness or flexibility of the body shell to provide comfort to the children seated thereon. The body shell generally includes a fastening mechanism to attach the clothing or pad thereon. Such arrangement increases the manufacturing cost and assembling time.

### SUMMARY OF THE INVENTION

One object of the present invention is to provide a child seat without clothing. The child seat comprises a flexible member integrally formed on the body. No additional seat clothing or pad is needed to be attached onto the body.

### BRIEF DESCRIPTION OF THE DRAWINGS

Referring now to the attached drawings which form a part of this original disclosure:

FIG. 1 is a perspective view showing a child car seat according to the first embodiment of the present invention;

FIG. 2 is a side view of the child car seat shown in FIG. 1;

FIG. 3 is a perspective view showing an infant carrier according to the second embodiment of the present invention;

FIG. 4 is a perspective view showing another child car seat according to the third embodiment of the present invention; and

FIG. 5 is a perspective view showing a high chair according to the fourth embodiment of the present invention.

### DETAILED DESCRIPTION OF THE PREFERRED EMBODIMENTS

Selected embodiments of the present invention will now be explained with reference to the drawings.

### First Embodiment

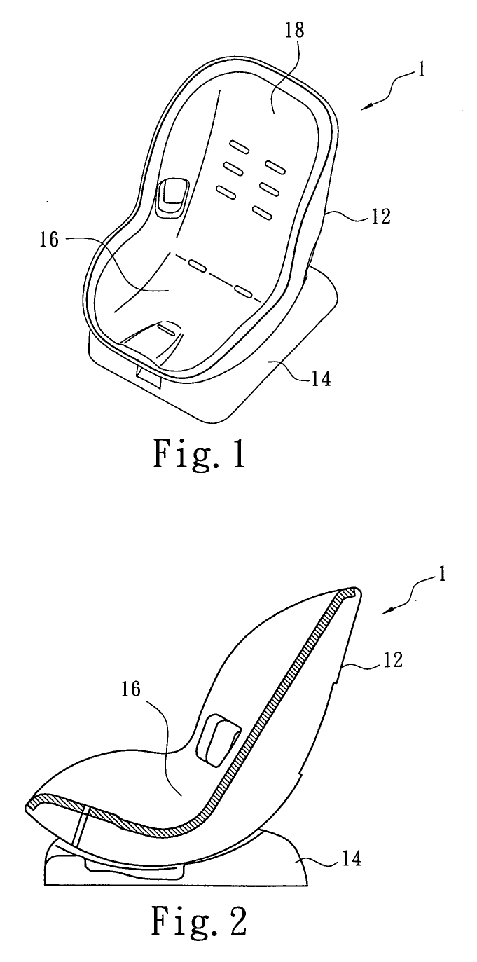

With reference to FIGS. 1 and 2, in the first embodiment of the present invention, the child seat is a child car seat 1 that comprises a seat portion 12 and a base portion 14. The seat portion 12 is removably coupled to the base portion 14. The seat portion 12 comprises a body 18 and a flexible member 16 located above the body 18. The flexible member 16 is integrally formed directly on the body 18 of the child car seat 1 by over molding process. After the over molding process, the flexible member 16 is attached onto the upper surface of the body 18, and conforms to the shape of the body 18, and is unremovable from the body. Therefore, the flexible member 16 may provide the functions as pad or seat clothing, and the clothing or pad is no longer needed.

The two-step molding process of the seat portion 12 comprises the steps of: forming a rigid body 18 by injection molding a first thermoplastic such as PP polypropylene in an injection mold; thereafter placing the body 12 in another mold to over-mold the body 12 with a second thermoplastic so as to form a flexible member 16 that is attached on the upper surface of the body 18. The first and second thermoplastics are formed of different materials. For example, the second thermoplastic can be formed of elastomers such as IPV, SEBS, PU foam, EUAEPS, EPO, or EPP. cl Second Embodiment

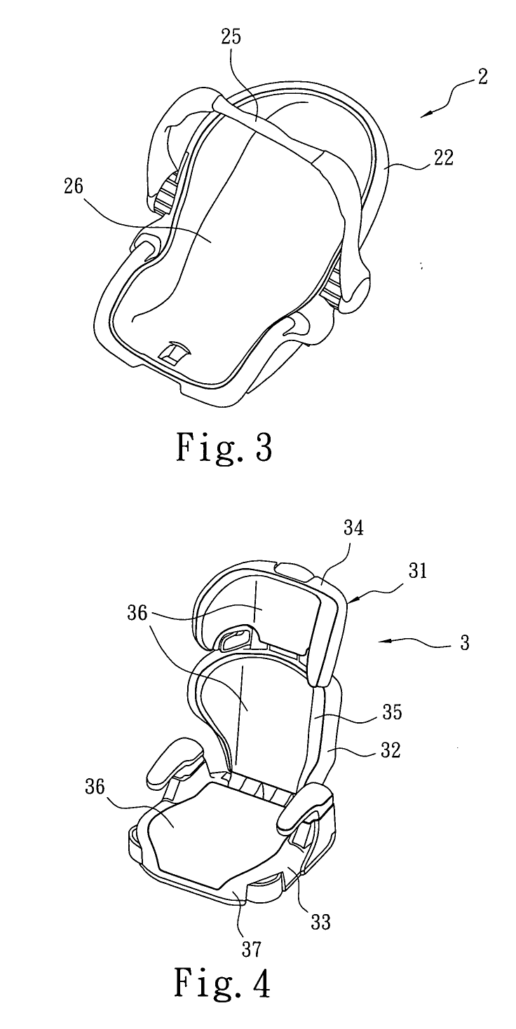

FIG. 3 shows an infant carrier according to the second embodiment of the present invention. The infant carrier 2 comprises a body portion 22 and a flexible member 26. The flexible member 26 is directly formed on the upper surface of the body portion 22 by over-molding process as described in the first embodiment. The infant carrier 2 includes a handle 25 to facilitate the handling of the users such as the parents.

### Third Embodiment

FIG. 4 is a perspective view showing another child car seat according to the third embodiment of the present invention. The child car seat 3 comprises a headrest portion 31, a backrest portion 32 and a seat portion 33. The headrest portion 31 comprises a body 34 and a flexible member 36 attaching to the body 34. The headrest portion 31 is located above the backrest portion 32, and is movable relative to the backrest portion 32 so that the height can be adjusted to suit children of different ages. The seat portion 33 comprises a body 37 and a flexible member 36 attaching to the body 37, and is located below the backrest portion 32. The backrest portion 32 comprises a body 35 and a flexible member 36 attaching to the body 35, and is removably connected to the seat portion 33. When the backrest portion 32 is removed, the seat portion 33 can serve as a booster for an elder child. The flexible member 36 is directly formed on the headrest portion 31, the backrest portion 32, and the seat portion 33 by over-molding process as described in the first embodiment. Therefore, the flexible member 36 may provide the functions as a pad or clothing, and clothing or pad is not be needed to attach to the headrest portion 31, backrest portion 32 and seat portion 33.

### Fourth Embodiment

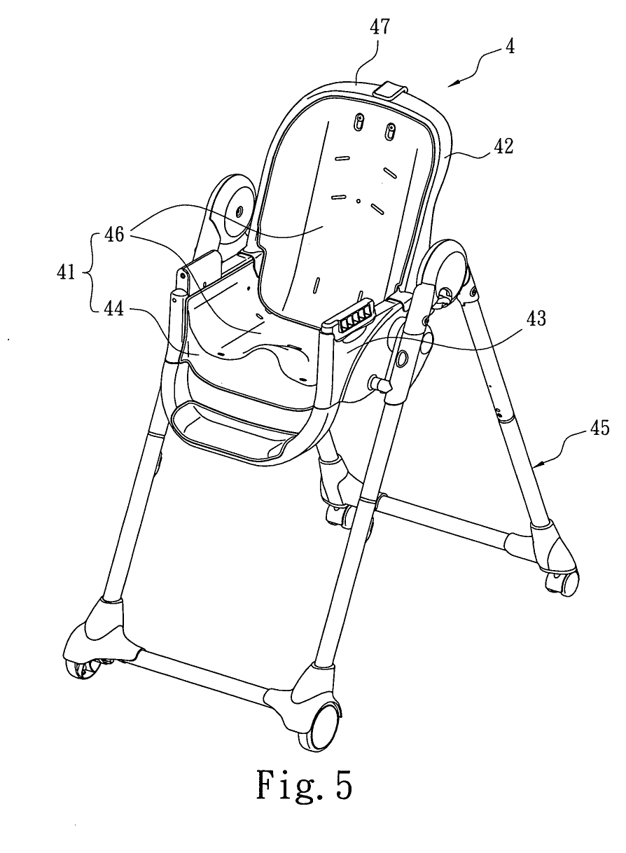

FIG. 5 is a perspective view showing a highchair according to the fourth embodiment of the present invention. The highchair 4 comprises a frame 45 and a seat 41 coupled to the frame 45. The seat 41 comprises a seat portion 43 and a backrest portion 42 located above the seat portion 43. The seat portion 43 comprises a seat body 44, and a flexible member 46 located above the body 44. The backrest portion 42 comprises a backrest body 47 and a flexible member 46 located above the backrest body 47. The seat 41 is height adjustable relative to the frame 45. The flexible member 46 is directly formed on the backrest body 47 of the backrest portion 42, and the seat body 44 of the seat portion 43 by over-molding process. Therefore, the flexible member 46 may provide the functions as a pad or clothing, even though no clothing or pad is provided for the backrest portion 42 and seat portion 43. Furthermore, since no clothing or pad is assembled on the respective portions, the backrest portion 42 may be tilted relative to the seat portion 43 to adjust for an appropriate inclination angle without any interference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A child seat comprising:
a body; and
a flexible member located on the body,
wherein the flexible member is integrally formed on the body by over-molding process.

2. The child seat according to claim 1, wherein the body comprises a first thermoplastic formed in an injection mold by injection molding.

3. The child seat according to claim 2, wherein the body is placed in another mold and is over-molded with a second thermoplastic to form the flexible member that is attached to the body.

4. The child seat according to claim 3, wherein the first and second thermoplastics are formed of different materials.

5. The child seat according to claim 4, wherein the first thermoplastic is polypropylene.

6. The child seat according to claim 1, wherein the flexible member is located above an upper surface of the body.

7. The child seat according to claim 5, wherein the second thermoplastic is an elastomer formed of IPV, SEBS, PU foam, EUAEPS, EPO, or EPP.

8. The child seat according to claim 4, wherein the child seat is either one of the child car seat, infant carrier or highchair.

9. A method of manufacturing a child seat comprising the steps of:
forming a body by injection molding a first thermoplastic in an injection mold;
placing the body in another mold to over-mold the body with a second thermoplastic so as to be attached on an upper surface of the body.

10. The method according to claim 9, wherein the first and second thermoplastics are formed of different materials.

11. The method according to claim 10, wherein the first thermoplastic is polypropylene.

12. The method according to claim 11, wherein the second thermoplastic is an elastomer formed of IPV, SEBS, PU foam, EUAEPS, EPO, or EPP.
